(19) United States
(12) Patent Application Publication
(10) Pub. No.: US 2002/0170046 A1
(43) Pub. Date: Nov. 14, 2002

(54) Encapsulating an interfact to a distributed programming component as a local component

(76) Inventors: Philip J. Goward, Portland, OR (US); William J. Leler, Portland, OR (US)

Correspondence Address: PARK, VAUGHAN & FLEMING LLP, 508 SECOND STREET, SUITE 201, DAVIS, CA, 95616, US

(21) Appl. No.: 09/792,464

(22) Filed: Feb. 23, 2001

(51) Int. Cl. G06F 9/44

(52) U.S. Cl. 717/162

(57) ABSTRACT

One embodiment of the present invention provides a system for encapsulating a distributed programming component as a local component in order to facilitate use of the distributed programming component. The system operates by receiving a command to import the distributed programming component. In response to this command, the system instantiates the local component and then generates method translations for the local component, so that method invocations to the local component cause corresponding operations involving the distributed programming component to take place. The system also initializes variables to be used in accessing the distributed programming component. Another embodiment of the present invention provides a system for referencing a distributed programming component through a local component. The system operates by receiving an invocation of a method defined within the local component, wherein the local component encapsulates the distributed programming component in order to allow the distributed programming component to be accessed as a local component. Next, if the method belongs to a first set of methods, the system uses indirection to call a corresponding method defined within the distributed programming component. On the other hand, if the method belongs to a second set of methods, the system executes code defined within the local component to facilitate operation of the distributed programming component.

### BACKGROUND

1. Field of the Invention

The present invention relates to the process of designing applications for distributed computing systems. More specifically, the present invention relates to a method and an apparatus for encapsulating a distributed programming component as a local component in order to facilitate use of the distributed programming component.

2. Related Art

As the Internet continues to expand at an exponential rate, thousands of new web sites are coming on line every day selling products as diverse as books and automobiles, and offering services, such as stock trading and electronic banking. Unfortunately, deploying a web site of any sophistication can be an expensive and time-consuming task, requiring a large investment in expensive programmer time.

In order to remedy this problem, it is becoming increasingly common to build web applications using pre-existing distributed components that are typically located on remote computing platforms. These distributed components can be used to perform computational tasks and other operations involved in implementing a web site. For example, a web server can communicate with a first distributed component located on a first application server to handle operations relating to shipping. At the same time the web server can communicate with a second distributed component located on a second application server to handle inventory operations. In this way, the web site can be deployed without having to write code to deal with shipping or inventory. Hence, using distributed components can greatly reduce the amount of work involved in developing a web application, and can thereby reduce cost.

Distributed components are typically accessed through an interface located on the local computer system. For example, an Enterprise JavaBean™ (EJB) that is located on a remote computer system can be accessed through a “home” interface and a “remote” interface located on the local computer system. The home interface generally includes generic methods, such as methods to create or find an EJB, whereas the remote interface includes methods that are specific to a particular EJB.

In spite of the advantages of using a distributed component, the task of accessing a distributed component can require a significant amount of programming effort. For example, in order to use a distributed component (such as an EJB) to find a set of books from a library, and to print the title and ISBN of each book, a web site programmer has to perform a number of tasks (see FIG. 6). First, the programmer must write code to initialize the EJB by finding the EJB and setting parameters for the EJB (step 602). Next, the programmer must write code to call the EJB to find the specific books (step 604). This call will typically return a list of books. The programmer must then write code to iterate through the list of books in order to output the title and the ISBN of each book (step 606).

Note that the web site programmer must write this type of code for each distributed component that the web site application makes use of. Furthermore, note that code written for a given distributed component typically cannot be reused for another distributed component.

Hence, what is needed is a method and an apparatus for reducing the amount of code that must be developed in order to make use of a distributed component.

### SUMMARY

One embodiment of the present invention provides a system for encapsulating a distributed programming component as a local component in order to facilitate use of the distributed programming component. The system operates by receiving a command to import the distributed programming component. In response to this command, the system instantiates the local component and then generates method translations for the local component, so that method invocations to the local component cause corresponding operations involving the distributed programming component to take place. The system also initializes variables to be used in accessing the distributed programming component.

In one embodiment of the present invention, if the method belongs to a first set of methods, the system generates a method translation by generating an indirect call to a method defined within the distributed programming component. On the other hand, if the method belongs to a second set of methods, the system generates a method translation by generating translated code within the local component.

In one embodiment of the present invention, generating the translated code involves generating code that is event-driven. In a variation on this embodiment, generating the code that is event-driven involves generating code within the local component that returns an event in addition to returning data.

In one embodiment of the present invention, initializing the variables to be used in accessing the distributed programming component involves initializing the variables using pre-established preferences.

In one embodiment of the present invention, receiving the command to import the distributed programming component involves receiving a Java Archive (JAR) file containing one or more EJBs, and then duplicating the JAR file at a location on a class path. It also involves scanning through a deployment descriptor in the JAR file to identify Enterprise JavaBeans (EJBs) specified within the JAR file. It additionally involves generating a JavaBean for each EJB identified within the JAR file so that each EJB can be accessed through a corresponding JavaBean.

In one embodiment of the present invention, the distributed programming component can include, an Enterprise JavaBean (EJB), a Distributed Component Object Model (DCOM) object, or a Common Object Request Broker Architecture (CORBA) object.

In one embodiment of the present invention, the local component can include a JavaBean or a Component Object Model (COM) object.

In one embodiment of the present invention, the distributed programming component is an Enterprise JavaBean (EJB) and the local component is a JavaBean. In this embodiment, importing the EJB involves combining functionality of a home interface and a remote interface of the EJB into the JavaBean.

Another embodiment of the present invention provides a system for referencing a distributed programming component through a local component. The system operates by receiving an invocation of a method defined within the local component, wherein the local component encapsulates the distributed programming component in order to allow the distributed programming component to be accessed as a local component. Next, if the method belongs to a first set of methods, the system uses indirection to call a corresponding method defined within the distributed programming component. On the other hand, if the method belongs to a second set of methods, the system executes code defined within the local component to facilitate operation of the distributed programming component.

### BRIEF DESCRIPTION OF THE FIGURES

FIG. 1 illustrates a collection of servers that operate together in accordance with an embodiment of the present invention.

FIG. 2 illustrates the structure of a JavaBean that is used to encapsulate an EJB in accordance with an embodiment of the present invention.

FIG. 3 is a flow chart illustrating the process of importing a JAR file in accordance with an embodiment of the present invention.

FIG. 4 is a flow chart illustrating the process of setting up a JavaBean to encapsulate an EJB in accordance with an embodiment of the present invention.

FIG. 5 is a flow chart illustrating the process of accessing an EJB through a JavaBean in accordance with an embodiment of the present invention.

FIG. 6 is a flow chart illustrating the prior art process of writing code to make use of an EJB.

FIG. 7 is a flow chart illustrating the steps involved in making use of an EJB in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Servers

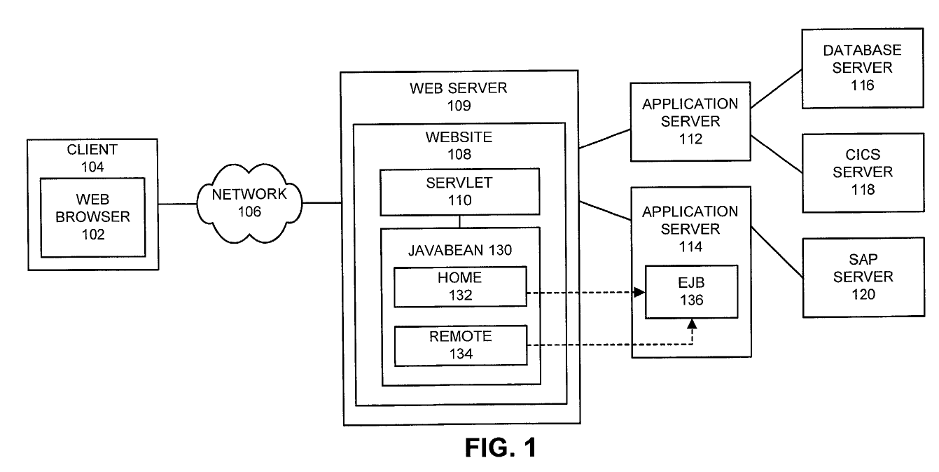

FIG. 1 illustrates a collection of servers that operate together in accordance with an embodiment of the present invention. In FIG. 1, a web browser 102 on client 104 communicates across network 106 with web site 108 on web server 109.

Client 104 can generally include any node on network 106 including computational capability and including a mechanism for communicating across network 106. Web browser 102 can generally include any type of web browser capable of viewing a web site, such as the INTERNET EXPLORER™ browser distributed by the Microsoft Corporation of Redmond, Wash.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Web server 109 can generally include any computational node including a mechanism for servicing requests from a client for computational and/or data storage resources. Web server hosts web site 108, which contains inter-linked pages of textual and graphical information that can be navigated through by a user operating web browser 102. Note that web site 108 contains a servlet 110. Servlet 110 is a program that runs on web server 109, and which can be executed by web server 109 or by another application on web server 109.

Web server 109 communicates with application servers 112 and 114 to perform some of the computational operations involved in implementing web site 108. Application servers 112 and 114 can in turn communicate with other servers, such as database server 116, CICS server 118 and SAP server 120, to gather information and/or to perform other computational operations.

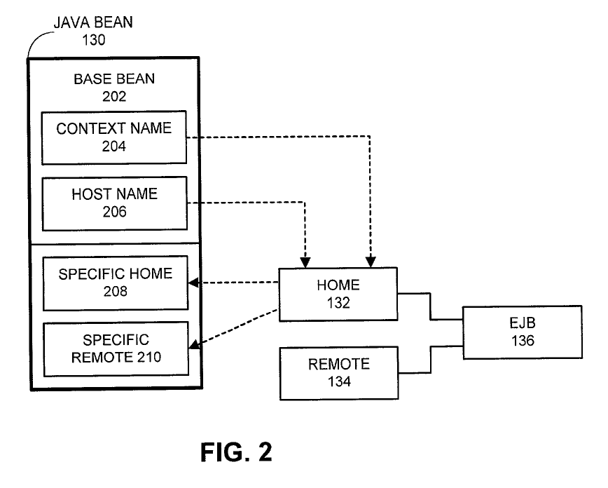

Web site 108 also includes a JavaBean 130, which encapsulates a home interface 132 and a remote interface 134 for an Enterprise JavaBean (EJB) located on application server 114. This encapsulation is described in more detail with reference to FIGS. 2-7 below.

Note that the present invention generally applies to any computing system that uses distributed components and is not meant to be limited to web-related applications.

Furthermore, the present invention is not meant to be limited to JavaBeans and EJBs. Hence, the present invention generally applies to all distributed components, including EJBs, DCOM objects and CORBA objects. The present invention also generally applies to all local components, including JavaBeans and COM objects.

JavaBean

FIG. 2 illustrates the structure of a JavaBean 130 that is used to encapsulate an EJB 136 in accordance with an embodiment of the present invention. JavaBean 130 includes a base bean 202, which contains a context name 204 and a host name 206. Context name 204 can be used to identify EJB 136, and host name 206 can be used to identify application server 114 that contains EJB 136.

Context name 204 is communicated to the naming lookup service of the application server identified by host name 206 to return home interface 132 in order to create or find EJB 136. EJB 136, which is returned by create or find via home interface 132, implements remote interface 134, and is used to establish specific remote 210 within JavaBean 130 in order to facilitate communication within EJB 136.

Note that specific home 208 and specific remote 210 include methods that can be used to communicate through home interface 132 and remote interface 134 with EJB 136.

Importing a JAR File

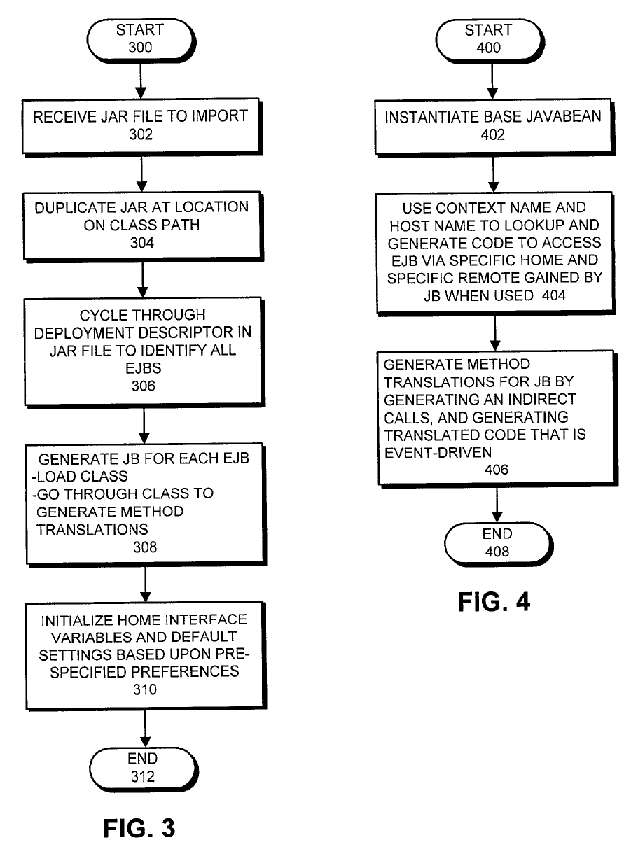

FIG. 3 is a flow chart illustrating the process of importing a JAR file containing one or more EJBs in accordance with an embodiment of the present invention. The system first receives a JAR file to import (step 302). This JAR file is first duplicated at a location on the class path of the product under development (step 304). Next, the system cycles through a deployment descriptor within the JAR file to identify EJBs specified within the JAR file (step 306).

The system then generates a JavaBean for each of the identified EJBs (step 308). This involves loading a class and then scanning through the class to generate method translations.

Next, the system initializes home interface access variables and default settings for each of the specified EJBs using pre-specified preferences (step 310). Note that this can involve combining preferences specified by the user with the deployment descriptor from the imported JAR file.

Setting Up a JavaBean

FIG. 4 is a flow chart illustrating the process of setting up a JavaBean 130 to encapsulate an EJB 136 in accordance with an embodiment of the present invention. The system starts by instantiating a base bean 202 (step 402), and then using context name 204 and host name 206 to lookup and generate code to access EJB 136 via specific remote home interface 208 and specific remote interface 210 gained by JavaBean 130 when used (step 404). Home interface 132 returns data that allows the system to implement specific home 208 and specific remote 210 interfaces for JavaBean 130.

The system generates a first set of method translations for JavaBean 130 by generating indirect calls to methods defined within EJB 136. The system also generates a second set of method translations for JavaBean 130 by generating translated (or transformed) code within JavaBean 130 (step 406). Note that this translated code can optionally be modified to be event-driven by writing code that returns an event (possibly along with accompanying data) in addition to a result. Note that an “event” is similar to an interrupt or a signal that is registered within the application.

Accessing an EJB Through a JavaBean

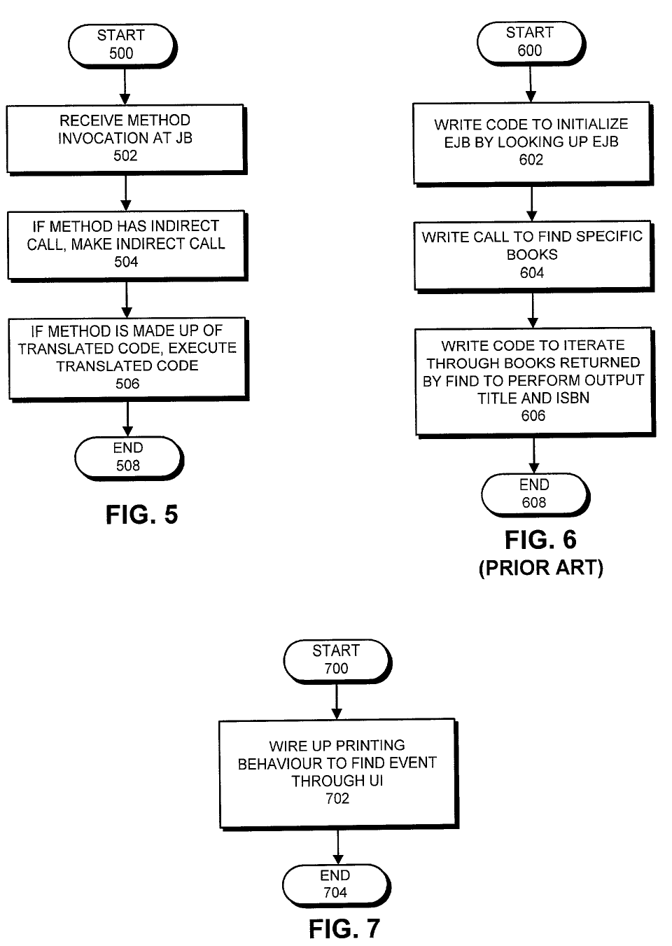

FIG. 5 is a flow chart illustrating the process of accessing an EJB 136 through a JavaBean 130 in accordance with an embodiment of the present invention. The system starts by receiving an invocation of a method defined within JavaBean 130 (step 502). If the method defined within JavaBean 130 specifies an indirect call, the system makes an indirect call to a method defined within EJB 136 (step 504). If the method defined within JavaBean 130 is made up of translated or transformed code, the system executes the translated or transformed code (step 506).

Making Use of an EJB

FIG. 7 is a flow chart illustrating the steps involved in making use of an EJB in accordance with an embodiment of the present invention. Like the example illustrated in FIG. 6, this example finds specific books and prints them out.

However, by using the present invention, this task is easily accomplished. One embodiment of the present invention uses a graphical user interface to wire up a behavior that prints out the title and the ISBN of the books to a “find event” that is generated when books are located (step 702). Note that the book finding process can be triggered by sending a find message to JavaBean 130. Also note that the behavior can be implemented with a simple line of code, such as “printTableRow[getTitle,getISBN].”

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for encapsulating a distributed programming component as a local component in order to facilitate use of the distributed programming component, comprising:
receiving a command to import the distributed programming component, in order to allow the distributed programming component to be accessed as a local component;
instantiating the local component through which the distributed programming component is to be accessed;
generating method translations for the local component, so that method invocations to the local component cause corresponding operations involving the distributed programming component to take place; and
initializing variables to be used in accessing the distributed programming component.

2. The method of claim 1 wherein generating the method translations involves:
generating an indirect call to a method defined within the distributed programming component if the method belongs to a first set of methods; and
generating translated code within the local component if the method belongs to a second set of methods.

3. The method of claim 2, wherein generating the translated code involves generating code that is event-driven.

4. The method of claim 2, wherein generating the code that is event-driven involves generating code within the local component that returns an event in addition to returning data.

5. The method of claim 1, wherein initializing the variables to be used in accessing the distributed programming component involves initializing the variables using pre-established preferences.

6. The method of claim 1, wherein receiving the command to import the distributed programming component involves:
receiving a Java Archive (JAR) file containing one or more EJBs;
duplicating the JAR file at a location on a class path;
scanning through a deployment descriptor in the JAR file to identify Enterprise JavaBeans (EJBs) specified within the JAR file; and
generating a JavaBean for each EJB identified within the JAR file so that each EJB can be accessed through a corresponding JavaBean.

7. The method of claim 1, wherein the distributed programming component can include one of:
an Enterprise JavaBean (EJB);
a Distributed Component Object Model (DCOM) object; and
a Common Object Request Broker Architecture (CORBA) object.

8. The method of claim 1, wherein the local component can include one of:
a JavaBean; and
a Component Object Model (COM) object.

9. The method of claim 1,
wherein the distributed programming component is an Enterprise JavaBean (EJB);
wherein the local component is a JavaBean; and
wherein importing the EJB involves combining functionality of a home interface and a remote interface of the EJB into the JavaBean.

10. A method for referencing a distributed programming component through a local component, comprising:
receiving an invocation of a method defined within the local component, wherein the local component encapsulates the distributed programming component in order to allow the distributed programming component to be accessed as a local component;
if the method belongs to a first set of methods, using indirection to call a corresponding method defined within the distributed programming component; and
if the method belongs to a second set of methods, executing code defined within the local component to facilitate operation of the distributed programming component.

11. The method of claim 10, wherein executing the code defined within the local component involves executing code that is event-driven.

12. The method of claim 11, wherein executing the code that is event-driven involves executing code within the local component that returns an event in addition to returning data.

13. A computer-readable storage medium storing instructions that when executed by a computer cause the computer to perform a method for encapsulating a distributed programming component as a local component in order to facilitate use of the distributed programming component, the method comprising:
receiving a command to import the distributed programming component, in order to allow the distributed programming component to be accessed as a local component;
instantiating the local component through which the distributed programming component is to be accessed;
generating method translations for the local component, so that method invocations to the local component cause corresponding operations involving the distributed programming component to take place; and
initializing variables to be used in accessing the distributed programming component.

14. The computer-readable storage medium of claim 13, wherein generating the method translations involves:
generating an indirect call to a method defined within the distributed programming component if the method belongs to a first set of methods; and
generating translated code within the local component if the method belongs to a second set of methods.

15. The computer-readable storage medium of claim 14, wherein generating the translated code involves generating code that is event-driven.

16. The computer-readable storage medium of claim 14, wherein generating the code that is event-driven involves generating code within the local component that returns an event in addition to returning data.

17. The computer-readable storage medium of claim 13, wherein initializing the variables to be used in accessing the distributed programming component involves initializing the variables using pre-established preferences.

18. The computer-readable storage medium of claim 13, wherein receiving the command to import the distributed programming component involves:
receiving a Java Archive (JAR) file containing one or more EJBs;
duplicating the JAR file at a location on a class path;
scanning through a deployment descriptor in the JAR file to identify Enterprise JavaBeans (EJBs) specified within the JAR file; and
generating a JavaBean for each EJB identified within the JAR file so that each EJB can be accessed through a corresponding JavaBean.

19. The computer-readable storage medium of claim 13, wherein the distributed programming component can include one of:
an Enterprise JavaBean (EJB);
a Distributed Component Object Model (DCOM) object; and
a Common Object Request Broker Architecture (CORBA) object.

20. The computer-readable storage medium of claim 13, wherein the local component can include one of:
a JavaBean; and
a Component Object Model (COM) object.

21. The computer-readable storage medium of claim 13,
wherein the distributed programming component is an Enterprise JavaBean (EJB);
wherein the local component is a JavaBean; and
wherein importing the EJB involves combining functionality of a home interface and a remote interface of the EJB into the JavaBean.

22. A computer-readable storage medium storing instructions that when executed by a computer cause the computer to perform a method for referencing a distributed programming component through a local component, the method comprising:
receiving an invocation of a method defined within the local component, wherein the local component encapsulates the distributed programming component in order to allow the distributed programming component to be accessed as a local component;
if the method belongs to a first set of methods, using indirection to call a corresponding method defined within the distributed programming component; and
if the method belongs to a second set of methods, executing code defined within the local component to facilitate operation of the distributed programming component.

23. The computer-readable storage medium of claim 22, wherein executing the code defined within the local component involves executing code that is event-driven.

24. The computer-readable storage medium of claim 23, wherein executing the code that is event-driven involves executing code within the local component that returns an event in addition to returning data.

25. An apparatus that encapsulates a distributed programming component as a local component in order to facilitate use of the distributed programming component, comprising:
a receiving mechanism that is configured to receive a command to import the distributed programming component, in order to allow the distributed programming component to be accessed as a local component;
an instantiation mechanism that is configured to instantiate the local component through which the distributed programming component is to be accessed;
a translation mechanism that is configured to generate method translations for the local component, so that method invocations to the local component cause corresponding operations involving the distributed programming component to take place; and
an initialization mechanism that is configured to initialize variables to be used in accessing the distributed programming component.

26. The apparatus of claim 25, wherein the translation mechanism is configured to:
generate an indirect call to a method defined within the distributed programming component if the method belongs to a first set of methods; and to
generate translated code within the local component if the method belongs to a second set of methods.

27. The apparatus of claim 26 wherein the translation mechanism is configured to generate code that is event-driven.

28. The apparatus of claim 26, wherein the translation mechanism is configured to generate code that is event-driven by generating code within the local component that returns an event in addition to returning data.

29. The apparatus of claim 25, wherein the initialization mechanism is configured to initialize the variables using pre-established preferences.

30. The apparatus of claim 25, further comprising an importing mechanism that is configured to:
receive a Java Archive (JAR) file containing one or more EJBs;
duplicate the JAR file at a location on a class path;
scan through a deployment descriptor in the JAR file to identify Enterprise JavaBeans (EJBs) specified within the JAR file; and to
generate a JavaBean for each EJB identified within the JAR file so that each EJB can be accessed through a corresponding JavaBean.

31. The apparatus of claim 25, wherein the distributed programming component can include one of:
an Enterprise JavaBean (EJB);
a Distributed Component Object Model (DCOM) object; and
a Common Object Request Broker Architecture (CORBA) object.

32. The apparatus of claim 25, wherein the local component can include one of:
a JavaBean; and
a Component Object Model (COM) object.

33. The apparatus of claim 25,
wherein the distributed programming component is an Enterprise JavaBean (EJB);
wherein the local component is a JavaBean; and
wherein the apparatus is configured to combine functionality of a home interface and a remote interface of the EJB into the JavaBean.

34. An apparatus that references a distributed programming component through a local component, comprising:
a receiving mechanism that is configured to receive an invocation of a method defined within the local component, wherein the local component encapsulates the distributed programming component in order to allow the distributed programming component to be accessed as a local component;
an execution mechanism, wherein,
if the method belongs to a first set of methods, the execution mechanism is configured to use indirection to call a corresponding method defined within the distributed programming component; and
if the method belongs to a second set of methods, the execution mechanism is configured to execute code defined within the local component to facilitate operation of the distributed programming component.

35. The apparatus of claim 34, wherein the execution mechanism is configured to execute code that is event-driven.

36. The apparatus of claim 34, wherein the execution mechanism is configured to execute code that is event-driven by executing code within the local component that returns an event in addition to returning data.
